(19) United States
(12) Patent Application Publication
(10) Pub. No.: US 2025/0104111 A1
(43) Pub. Date: Mar. 27, 2025

(54) PREDICTING EXTERNAL BALANCE TRANSFER SYSTEM AND METHOD

(71) Applicant: The PNC Financial Services Group, Inc., Pittsburgh, PA (US)

(72) Inventors: Hui Wang, New Castle, DE (US); Jun Ni, Newark, DE (US); James Lekachman, Pittsburgh, PA (US)

(21) Appl. No.: 14/526,910

(22) Filed: Oct. 29, 2014

Related U.S. Application Data
(60) Provisional application No. 61/898,005, filed on Oct. 31, 2013.

(51) Int. Cl. G06Q 30/0251; G06Q 20/10

(52) U.S. Cl. CPC G06Q 30/0255; G06Q 20/10

(57) ABSTRACT

A system and method for determining a likelihood of response to a Balance Transfer (“BT”) offer includes developing a pattern recognition model based on BT response information contained in tradeline level data that has external tradeline information of a plurality of customers of a host financial institution, applying the pattern recognition model to the external tradeline information of the customers to determine a probability of whether the external tradeline information indicates that an BT offer was accepted by a customer, developing an overall customer account level model based on desired historical account behavior, applying the account level model to historical account behavior information of the customers to determine a likelihood of whether each customer will accept a BT offer from an external financial institution, and ranking the customers based on the determined probability and the likelihood that each customer would accept a BT offer from an external financial institution.

### CROSS-REFERENCE TO RELATED APPLICATIONS

This patent application claims the benefit of, and priority to, co-pending U.S. Provisional Patent Application No. 61/898,005, filed on Oct. 31, 2013, which is incorporated by reference herein in its entirety.

### FIELD OF THE DISCLOSURE

The present disclosure is generally directed towards a system and method for using tradeline data to develop a model that predicts an acceptance of external Balance Transfer (“BT”) offers.

### BACKGROUND OF THE INVENTION

In credit card portfolio management, a Balance Transfer (“BT”) program is a primary driver for balance build and growth. Existing BT strategies capture responses to internal BT programs for a host entity, such as a bank, credit issuer, or other type of financial institution, and draw models from this information to target customers that have a higher chance of responding to offers and have higher expected BT amounts, or draw amounts. However, to expand market share, there is a need to identify those customers who are more likely to respond to offers from a host entity's competitors. After identifying those customers, BT offers can be mailed with proper (which may be more competitive) conditions to boost the chance that an individual or customer may accept the offer.

The biggest challenge to developing a model regarding the identity of customers who are likely to respond to offers from an entity's competitors is that the information about external BT response is not available to use. In this context, external BT response information means BT responses to BT offers that are from sources other than the host entity. In fact, modeling BT response behavior is difficult because of a lack of shared industry data regarding responses to BT offers. Credit issuers do not share their BT response information with their competition. Therefore, although other information is available, the actual BT response information is not available in credit bureau files. Thus, there is a need for a system and method that allows for creating accurate and reliable procedures to derive information regarding external BT activities.

### SUMMARY OF THE INVENTION

FIG. 1 is a diagram of a prior art Reject Inference (“RI”) method for determining, based on inference, the loan status of a population of applicants for credit. An RI system starts with a pool of Through-The-Door (“TTD”) applicants 102, which includes approved and declined applicants for a credit line or loan. The TTD applicants are then split into Approved sample set 104 and Declined sample set 106. As shown in FIG. 1, a Good/Bad Model 105 is built on the Approved sample set 104, which includes Known Goods 101 and Known Bads 103. Known Goods 101 and Known Bads 103 (together called “KGBs”) refer to the creditwise performance of approved accounts that can be observed and is thus referred to as “known.” However, as the performance of declined accounts is not observable the Good/Bad Model cannot be built from the Decline sample set 106.

The Good/Bad Model 105 is then applied to the Declined sample set 106 and the results are assigned inferred outcome probabilities of good 107 and bad 108 since a target classification would typically be a binary result-either good or bad. Bad for a risk model is typically defined as 90+ day delinquency within an 18 month performance window and given the account has current status today. The probabilities can be used to simulate the outcomes on the Declined sample set 106, either by simulation 111 or by fuzzy augmentation 112, which includes assigning fractions of goods 109 and bads 110 to an account. With the inferred outcome, a final model 100 is developed on the entire TTD population 102.

RI is based on various techniques such as Expert Estimation, Augmentation, Extrapolation, and Cohort Performance. Cohort Performance includes using external behavior as a proxy for internal behavior. Extrapolation 120 is the process by which a model is built based on approved applicants and applying it to the declined applicants to infer the good/bad performance.

A reason for using the RI method is that the good/bad status of declined applicants will never be known since a declined account's performance cannot be observed; only an approved account's performance can be observed. However, by developing a model based only on an approved population, that model will be flawed because selection bias is generated. KGBs 101, 103 in an approved population 104 do not accurately represent the entire TTD population 102. Thus, the population is inherently biased toward approved applications and a Good/Bad Model 105 built upon the KGBs 101, 103 data will be flawed.

Moreover, final models are generally meant to be used on an entire TTD population, not simply on a KGB population. As shown in FIG. 1, an RI method assigns an inferred outcome, good or bad, to the Declined sample set 106, which are included in the scorecard building 100. The scorecard is a statistically based predictive model used in credit risk modeling for attributing a number, or score, to a customer or an account associated with a customer. The score indicates the predicted probability that the customer or account will become “bad” within a given timeframe. By doing so, the scorecard is more representative of the entire applicant population and any sample bias can be minimized.

The present disclosure is related to using tradeline data to develop a model that predicts the Balance Transfer (“BT”) response likelihood to a potential customer that is outside of a host entity's, such as a financial institution, organization. An innovative pattern recognition approach is used to identify outside BT related activities, which are not observable by the host entity. The pattern recognition is based the details about a customers' balance on individual accounts, including the current balance divided by credit line limit, as known as utilization, and balance patterns. A higher utilization may indicate that a customer has borrowed more and has less room for further borrowing. An external BT response likelihood model can be built to be used in conjunction with internal BT response models to help identify a group of customers for better targeting and pricing strategy.

According to the present disclosure, developing a model begins by looking at tradeline data. Tradeline data is a credit report industry term for “individual loans”. When a borrower opens a line of credit, such as for example, a credit card, a car loan, or a home mortgage, these accounts will be reported by the credit grantor to a consumer credit reporting agency, also called a national credit bureau, as tradelines. One customer could have multiple tradelines; e.g. one credit card account from a first financial institution, one car loan from a second financial institution, one mortgage from a third financial institution, etc. A tradeline defines the consumer's account status and activity at the individual line of credit level. Tradeline entries includes names of the entity or institution where the borrower has accounts, dates accounts were opened, credit limit, type of accounts, balance, payment history, etc. Certain portions of these tradeline entries may be encrypted due to confidentiality issues and are therefore not available to users.

The tradeline level data is recently available in the industry but was almost never used in credit strategies due to complexity. Although customer or overall customer account level modeling has been widely available in the credit card market, tradeline level modeling has not been used in the past.

To protect the confidentiality of the individual issuers, company names are removed in the tradeline data and thus not available to users. Thus, according to embodiments of the present disclosure, a matching logic was created to identify internal versus external trades. According to one preferred embodiment a match rate above 90% was achieved. A summary mathematical function was also created to link tradeline level modeling results to the next stage of modeling at the overall customer account level, where the summary mathematical function is the maximum of all tradeline probabilities.

An innovative pattern recognition approach was developed to identify external behavior based on customers' tradeline change patterns. A major difference from traditional statistical modeling is that only utilization and balance patterns were used and no behavior or profile attributes were selected. Initial testing proved the model algorithm to be very effective.

As disclosed herein, a method for determining a likelihood of response to a Balance Transfer (“BT”) offer comprises providing a computer system comprising at least a processor operatively associated with a non-transitory computer usable storage medium, developing, via the computer system, a pattern recognition model based on BT response information contained in tradeline level data, applying, via the computer system, the pattern recognition model to the external tradeline information of the plurality of customers to determine a probability of whether the external tradeline information indicates that an BT offer was accepted by a customer associated with the external tradeline information, developing, via the computer system, an overall customer account level model based on desired historical account behavior, and, ranking, via the computer system, the plurality of customers based on the determined probability and the likelihood that each customer of the plurality of customers would accept a BT offer from the financial institution. The tradeline level data comprises external tradeline information of a plurality of customers of a host financial institution.

The method further requires applying the overall customer account level model to historical account behavior information of the plurality of customers to determine a likelihood of whether each customer will accept a BT offer from a financial institution other than the host financial institution and ranking the plurality of customers based on the determined probability and the likelihood that each customer of the plurality of customers would accept a BT offer from the financial institution.

In another preferred embodiment, the method further comprises providing, via the computer system, a BT offer based on the ranking of a customer of the plurality of customers.

In yet another preferred embodiment, the method further comprises determining, via the computer system, an amount for a BT offer to a customer of the plurality of customers based on the ranking of the customer of the plurality of customers.

In still another preferred embodiment, the method further comprises determining, via the computer system, an interest rate for a BT offer to a customer of the plurality of customers based on the ranking of the customer of the plurality of customers.

In a further preferred embodiment, the tradeline level data comprises monthly data and wherein building the pattern recognition model based on BT response information comprises matching, via the computer system, the tradeline level data on monthly basis for a predetermined period.

In yet a further preferred embodiment, the tradeline level data comprises at least one of a date for an opening of an account, a credit limit on an account, a type of account, a balance of an account, and a payment history of an account.

In still a further preferred embodiment, building the pattern recognition model based on BT response information further comprises at least one of matching, via the computer system, an account number in the tradeline level data for a first month with an account number in the tradeline level data for a second month, matching, via the computer system, a date for an opening of an account in the tradeline level data for a first month with a date for an opening of an account in the tradeline level data for a second month, and matching, via the computer system, an account type in the tradeline level data for a first month with a date for an account type in the tradeline level data for a second month.

In another preferred embodiment, the tradeline level data comprises internal tradeline information of the plurality of customers of the financial institution and wherein building the pattern recognition model based on BT response information comprises identifying, via the computer system, the internal tradeline information and isolating, via the computer system, the internal tradeline information from the external tradeline information.

In yet another preferred embodiment, the method further comprises executing, via the computer system, a BT offer campaign and the tradeline level data comprises information gathered during the BT offer campaign.

Also disclosed herein, a method for determining a likelihood of response to a Balance Transfer (“BT”) offer comprises providing a computer system comprising at least a processor operatively associated with a non-transitory computer usable storage medium, gathering, via the computer system, tradeline data for overall accounts of customers of a host financial institution according to BT responders and BT non-responders, extracting, via the computer system, internal tradeline information and overall customer account level attributes from the tradeline data of the overall accounts of the customers of the host financial institution according to BT responders and BT non-responders, and, developing, via the computer system, a pattern recognition model based on the extracted internal tradeline information and account level attributes. The BT responders are customers of the host financial institution that have accepted a BT offer from the host financial institution and the BT non-responders are customers of the host financial institution that have not accepted a BT offer from the host financial institution.

The method further requires applying, via the computer system, the pattern recognition model to external tradeline information of the customers to determine a probability of whether the external tradeline information indicates that a BT offer was accepted by a customer associated with the external tradeline information, developing, via the computer system, an overall customer account level model based on desired account level attributes, and applying the overall customer account level model to the overall customer account level attributes of the customers to determine a likelihood of whether each customer will accept a BT offer from a financial institution other than the host financial institution.

The method also requires ranking, via the computer system, the plurality of customers based on the determined probability and the likelihood that each customer of the plurality would accept a BT offer from a financial institution other than the host financial institution and providing a BT offer to at least one customer of the customers of the host financial institution based on the ranking.

In another preferred embodiment, the tradeline data comprises at least one of a date for an opening of an account, a credit limit on an account, a type of account, a balance of an account, and a payment history of an account, among other items.

In yet another preferred embodiment, building the pattern recognition model based on the extracted internal tradeline information and overall customer account level attributes comprises at least one of matching, via the computer system, an account number in the tradeline level data for a first month with an account number in the tradeline level data for a second month, matching, via the computer system, a date for an opening of an account in the tradeline level data for a first month with a date for an opening of an account in the tradeline level data for a second month, and matching, via the computer system, an account type in the tradeline level data for a first month with a date for an account type in the tradeline level data for a second month.

In a further preferred embodiment, the method further comprises deriving, via the computer system, a variable to determine tradeline activity, wherein the variable comprises at least one of a tradeline balance change between a first month and a second month, a maximum of a tradeline balance change between monthly periods over a predetermined number of months, a tradeline utilization between a first month and a second month, a maximum of a tradeline utilization between monthly periods over a predetermined number of months, and a number of months since a tradeline was opened.

In still a further preferred embodiment, the method further comprises deriving, via the computer system, a variable to determine overall customer account level activity, wherein the variable comprises at least one of a total number of tradelines associated with a customer, an average credit limit for a total number of tradelines associated with a customer, a sum of balances of all tradelines associated with a customer at a first month, a sum of balances of all tradelines associated with a customer at a second month, an average balance of all tradelines associated with a customer between monthly periods over a predetermined number of months, and a maximum of an average balance of all tradelines associated with a customer between monthly periods over a predetermined number of months.

In yet a further preferred embodiment, the method further comprises determining, via the computer system, an amount for the BT offer to the customer based on the ranking of the customer.

In another preferred embodiment, the tradeline level data comprises monthly data and wherein building the pattern recognition model based on the extracted internal tradeline information and overall customer account level attributes comprises matching, via the computer system, the tradeline level data on a monthly basis for a predetermined period.

In still another preferred embodiment, building a pattern recognition model based on the extracted internal tradeline information and overall customer account level attributes comprises isolating, via the computer system, the internal tradeline information from the external tradeline information.

In yet another preferred embodiment, the method further comprises executing, via the computer system, a BT offer campaign to the customers of the financial institution, wherein the tradeline data comprises information gathered during the BT offer campaign.

In a further preferred embodiment, the account level attributes comprise at least one of an overall balance to credit amount ratio on open revolving trades in a predetermined period, total number of bankcard revolving and national trades, total credit amount on open revolving bankcard trades in a predetermined period, average period of time since trades were opened, total number of opened and closed trades with positive balance in a predetermined period, lifetime high balance amount.

The disclosed predictive model implemented in accordance with disclosed methods increases the functionality and robustness of disclosed systems executing such predictive models. Disclosed methods employ embodiments of the predictive model to not only enable concerted operation and efficient data transfer between system components, but they reduce infrastructure and increase computational operability thereof. Disclosed methods provide for orchestrated transfer of data to yield predictive results that would otherwise, under prior art methods and systems, require additional data acquisitioning and processing by additional devices. Disclosed methods further provide for a significant reduction in analytical and computational process that would have to be performed by additional entities and/or devices if prior art methods and systems were employed to obtain the same and/or similar predictive results. Not only does the predictive model reduce the number of variables needed to yield an accurate predictive result, embodiments of the predictive model yield improved results from data (e.g., tradeline data) prior art models are unable to utilize. Furthermore, such data is readily ascertainable, whereas prior art systems and methods require data that is only ascertainable via third party entities and via networking with additional system devices.

Disclosed methods enable disclosed systems to further exploit embodiments of the predictive model to effectively and efficiently devise business process schemes in a computationally minimal manner. This may result in improved customer profiling and pricing and offering strategies, which would vastly reduce business marketing and operations costs, real and monetary. An entity implementing the disclosed methods can more precisely target which individuals are more likely to respond to and external balance transfer offer and, thus, are better able to selectively modify their offerings.

### BRIEF DESCRIPTION OF THE DRAWINGS

Further possible embodiments are shown in the drawings. The present invention is explained in the following in greater detail as an example, with reference to exemplary embodiments depicted in drawings. In the drawings:

FIG. 1 is a diagram of Reject Inference method of the prior art;

FIG. 2 is a diagram of a process for Balance Transfer (“BT”) mailing and pricing strategy and enhancement opportunity as used in a preferred embodiment of the present disclosure;

FIG. 3 is a flowchart of the data collection and modeling process of a preferred embodiment of the present disclosure;

FIG. 4 is a diagram illustrating the collection of tradeline data and the creation of a target for overall customer account level modeling as used in a preferred embodiment of the present disclosure;

FIG. 5 is a diagram illustrating month to month tradeline data matching logic as used in a preferred embodiment of the present disclosure;

FIG. 6 is a diagram illustrating the identification of internal tradeline information among tradeline data as used in a preferred embodiment of the present disclosure;

FIG. 7 is a diagram illustrating the derivation of tradeline level and overall customer account level variables according to a preferred embodiment of the present disclosure;

FIG. 8 shows the model performance of the Tradeline Level BT Response Model according to a preferred embodiment of the present disclosure;

FIG. 9 shows the model performance of the Overall Customer Account Level External BT Response Model according to another preferred embodiment of the present disclosure; and

FIG. 10 is a component diagram of a computer device that implements a preferred embodiment of the present disclosure.

### DETAILED DESCRIPTION OF THE INVENTION

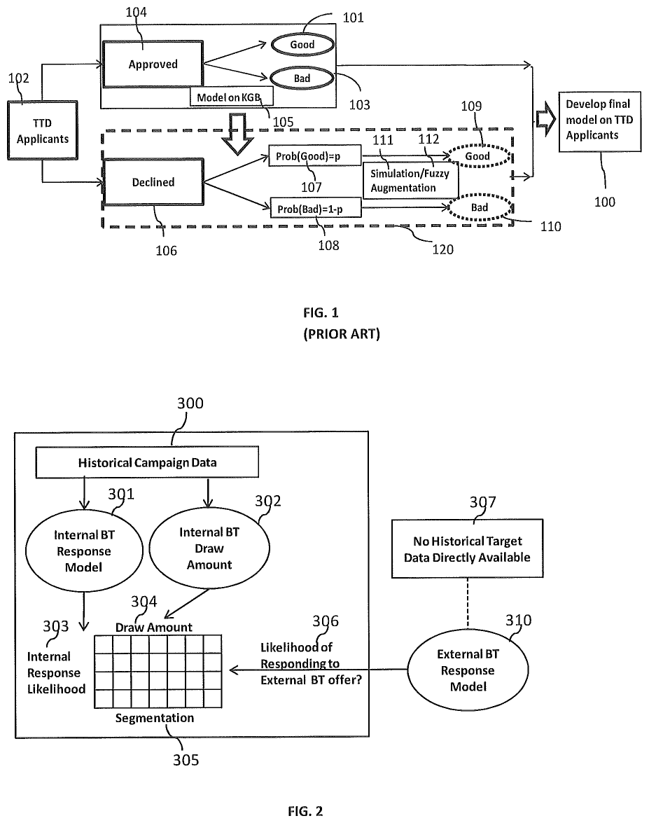

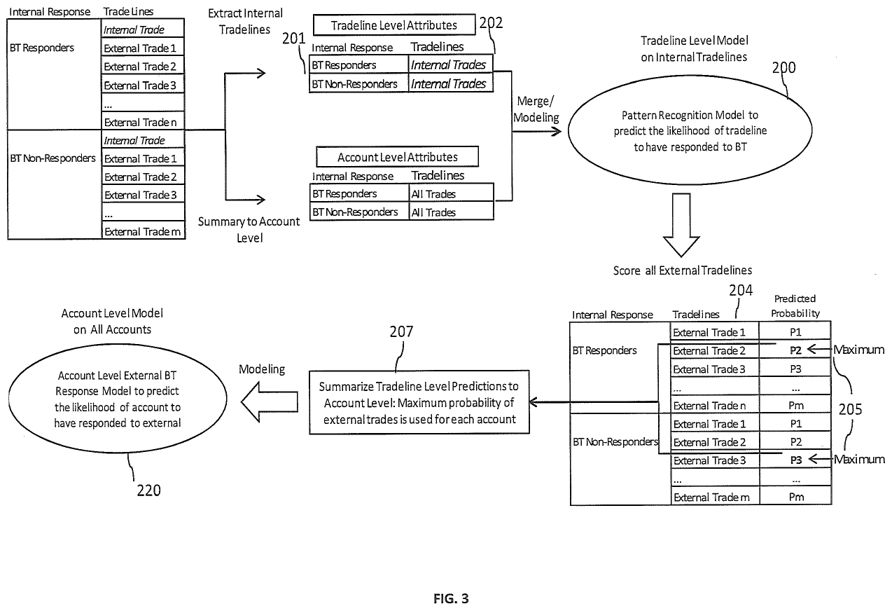

Balance Transfer (“BT”) and Convenience Check campaigns to credit card holders offer a major opportunity for balance building, and are considered the bread and butter of credit card portfolio management. FIG. 2 is a diagram of the current process for Balance Transfer (“BT”) mailing and pricing strategy and enhancement opportunity according to a preferred embodiment of the present disclosure. Historical campaign data 300 can be used to develop an internal BT response likelihood model 301 to measure a customer's response likelihood 303.

An internal BT draw amount model 302 can also be developed to predict how much additional balance 304 will be added if a customer accepts to an offer. The two models may be combined to create segments 305 on which mailing and pricing strategy can be created. In general, accounts with a higher predicted likelihood of responding and/or higher predicted draw amounts are mailed a BT offer. In addition, accounts with a lower predicted likelihood of responding may be given better offers.

This strategy described above provides an effective system in saving mailing cost by controlling response rate and maximizing balance gain. However, it does not consider how likely a given customer is to respond to an external BT offer 306. Some customers that are less likely to respond to the internal BT offers could be more likely to respond to external offers. Internal, or “on-us”, is used to indicate a trade, transaction, or other function that occurs within a host financial institution's control, whereas external, or “off-us”, is used to indicate a trade, transaction, or other function that occurs outside of the host financial institution's control. The reason that a customer may be more likely to respond to an external BT offer could be that other issuers have better offers or the customer has a preference in borrowing from other issuers. If this type of customer is given more competitive offers, some customers may be willing to take an internal instead of an external offer. Thus, by identifying customers in this particular group and offering better opportunities, a host financial institution's total response rate and balance shares could be increased.

An external BT response likelihood model 310 may be developed to measure a customer's likelihood of responding to an external BT offer 306 from a financial institution other than a host financial institution of the customer. A challenge is present because there is no information about a customer's response to an external BT offer that is readily available to be modeled 307 by a host financial institution. Responses to external BT offers are not observable internally to a host financial institution. On the other hand, there are no fields in the shared credit bureau tables that accurately capture a customer's total BT activities. Although vendors have created rule-based fields for total BT activities, these fields do not validate well on many financial institutions' internal BT data.

To solve this problem, embodiments of the present disclosure use tradeline data to infer a customer's external response information. Tradeline data is a credit report industry term for “individual loans”. When a borrower opens a line of credit, such as a credit card, car loan, or a home mortgage, these accounts will be reported by the credit grantor to a consumer reporting agency (credit bureau) as tradelines. One customer could have multiple tradelines (e.g. one credit card account from a first bank, one car loan from a second bank, one mortgage from a third bank). Tradeline data defines the consumer's account status and activity. Entries in tradeline data include the names of the company where the borrower has accounts (encrypted in the data due to confidentiality therefore not available to users), dates accounts were opened, credit limit, type of accounts, balance, and payment history etc.

According to preferred embodiments of the present disclosure, a pattern recognition model is developed based on BT response information contained in tradeline level data. The pattern recognition model may be built on internal tradeline information of a plurality of customers of a financial institution where the customers' BT response activity is known. The tradeline level data may also comprise external tradeline information of the customers.

For external trades with unknown outcome, the pattern recognition model can be applied to the external tradeline information of the plurality of customers to determine a probability of whether the external tradeline information indicates that a BT offer was accepted by a customer associated with the external tradeline information. Thus, the pattern recognition model can be applied to obtain an inferred model target. The inferred model target is external BT response with a probability weight. An assumption is made that the customers that were eligible for BT offers with a host financial institution are also eligible with other issuers, those issuers that are external to a host financial institution, and were also mailed BT offers during that same time period.

### Overview

FIG. 3 is a flow chart showing data collection, target definition, and modeling process of a preferred embodiment of the present disclosure. A predictive modeling approach is used to infer an estimate of an external Balance Transfer (“BT”) response for a customer of a host entity, such as a financial institution using tradeline data that defines tradeline activities associated with that customer. As shown in FIG. 3, a pattern recognition model 200 is built on internal trades 202 at a tradeline level to predict the BT response 201 of a customer.

In its initial state, tradeline data may be obtained from a Credit Bureau (i.e., a second computing system separate from the host computing system) in a text file with very raw format. Business analytics software, such as an SAS program is used to import the file to a preferred data format. Based on the layout of the file provided by bureau, modeling steps may be done using the tradeline data in the preferred data format, such as an SAS data format. The chart below summarizes some of the raw tradeline variables that are used in developing the pattern recognition and overall customer account level models discussed below:

| Column name | Descriptions |
|---|---|
| Enhanced_Type | Enhanced type of business |
| kob | Kind of business: codes that are assigned |
| | to identify the tradeline's type of |
| | business, e.g. Auto, Banks, etc. |
| open_date | Open date of the tradeline |
| type_code | Codes that specifies the tradeline type, e.g. |
| | Auto loan, Home Improvement Loan etc. |
| terms | Define term (in months) of the tradeline |
| | such as one month, ten months, or |
| | revolving etc. |
| amount1 | Balance amount defined by Amount 1 |
| | qualifier. For example, on a revolving |
| | account, Amount 1 may be the limit |
| amount1_qual | Code that defines amount 1. L = Limit |
| | H = High balance O = Original C = Charge |
| | off amount Blank = Unknown |
| amount2 | Balance amount defined by Amount |
| | 2 qualifier. For example, on a revolving |
| | account, Amount 2 may be the high balance |
| | on the account. |
| amount2_qual | Code that defines amount 1. L = Limit H = |
| | High balance O = Original C = Charge |
| | off amount Blank = Unknown |
| balance_date | balance date |
| balance | Full dollar amount |
| CONTROLNUMBER | control number |
| SEQUENCENUMBER | sequence number |

In a preferred embodiment, tradeline data for overall accounts of customers of the financial institution is gathered according to BT responders and BT non-responders. The tradeline data may be gathered at predetermined time periods, for example on a monthly basis, associated with the execution of a BT offer campaign to the customers of the host financial institution and the tradeline level data may comprise information gathered during the BT offer campaign. The BT responders may be identified as customers of the host financial institution that have accepted a BT offer from the host financial institution and the BT non-responders may be identified as customers of the host financial institution that have not accepted a BT offer from the host financial institution.

Internal tradeline information and overall customer account level attributes may be extracted from the tradeline data of the overall accounts of the customers of the host financial institution and the pattern recognition model is developed based on the extracted internal tradeline information and overall customer account level attributes. As the internal trade information of customers of the host financial institution is known, it is readily accessible by the host financial institution. The pattern recognition model can be subsequently applied to all external trades 204 and a maximum predicted BT response probability 205 may be applied as the customer's tradeline level external BT likelihood of acceptance 207. With the external BT response probability as a weight for the target, a second stage or Overall Customer Account Level Model 220 can be built to predict the overall customer account level external BT likelihood of acceptance.

The Overall Customer Account Level Model may be based on desired historical account behavior and may be applied to historical account behavior information of the plurality of customers to determine a likelihood of whether each customer will accept an external BT offer from a financial institution other than the host financial institution. The customers of the host financial institution may be ranked based on the determined probability and the likelihood that each customer of the plurality of customers would accept a BT offer from an external financial institution. A BT offer may then be provided based on the ranking of a customer of the customers. In addition, an amount or an interest rate for a BT offer to a customer may be determined prior to providing the BT offer, based on the ranking of the customer of the plurality of customers. A more detailed breakdown of the methods and systems discussed above is provided below.

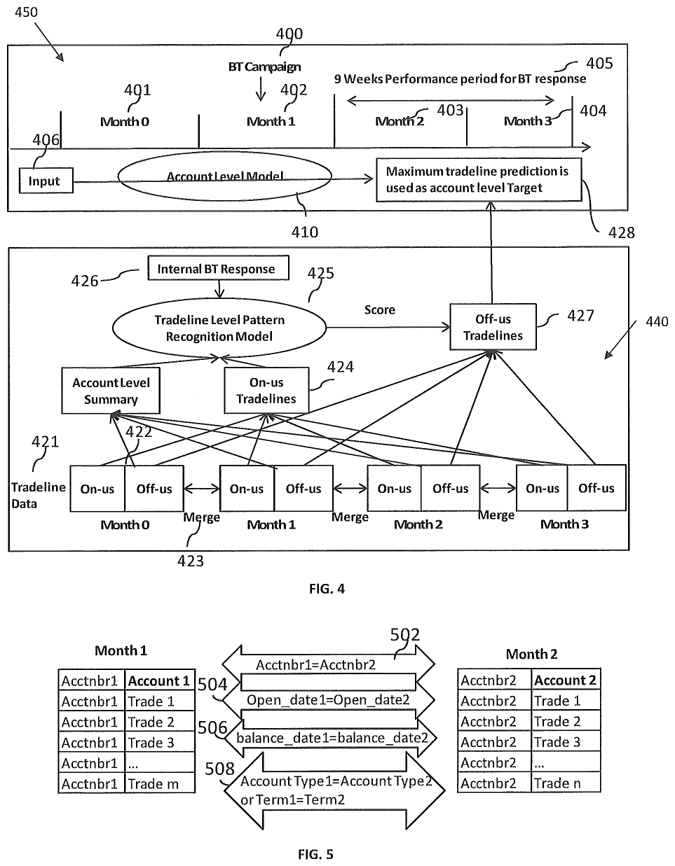

As shown in another preferred embodiment displayed in FIG. 4, credit bureau tradeline data 421 may be collected (i.e., from a second computing system separate from the host computing system), which identifies the internal tradelines. Monthly data to internal tradelines and external tradelines 422 can then be split or isolated, and four months of monthly data 423 regarding internal tradelines is merged to create the development data sets shown as “On-us Tradelines” 424. A pattern recognition model 425 is built based the internal BT response 426, and is applied to external tradeline information 427 to obtain a maximum value as the overall customer account level external BT response likelihood 428. The likelihood is then used as the model target to develop the second stage Overall Customer Account Level Model 410.

Further, as shown in 440 of FIG. 4, a BT campaign is conducted during Month 1 402, and the month prior to the first campaign month as Month 0 401. During the BT campaign, BT offers are mailed out. After a BT campaign 400 at Month 1 402, there is a 9 weeks response period 405 for the BT campaign, which includes the next two months as Month 2 403 and Month 3 404. The inferred external BT response in this period is used as a model target, and historical information before BT campaign is used as input 406 to develop an overall customer account level external BT response model 410.

Initially, internal BT campaign data with account numbers and response information are collected as a modeling sample. In the monthly tradeline data there is a number, code, or other identification, for example a sequence number, that identifies each customer. To match tradeline data to the customers identified and mailed offers during the campaign, a sequence number can be appended to the campaign data, which is available in the monthly account review file as part of the tradeline data. With the sequence number, the tradeline data can be identified and compared with corresponding campaign data.

Next, tradeline data before and after the BT campaign month is assembled and matched to form the modeling data so that patterns can be observed and modeled to predict BT response activities of customers of the financial institution. In the tradeline data, each customer may have multiple tradeline records with different companies or financial institutions that offer financial services. However, there is no other unique identifier for each tradeline as the names of the financial institutions are not available.

To assemble and match the tradeline data, a matching logic has been created. The tradeline data may be segmented according to a predetermined time periods, for example from month to month. As shown in a FIG. 5, adjacent months' tradeline data can be merged according to various conditions. Condition A, 502, matches account number to account number for each month of tradeline data. As shown in FIG. 5, condition A shows that Account Number 1 equals Account Number 2. Condition B, 504, makes sure the two months of tradeline data are of the same open date. As shown in FIG. 5, condition B shows that Open Date 1 equals Open Date 2. Condition C, 506, checks the balance date and connects the two months' records if the two balance dates are within 25-35 days of each other. As shown in FIG. 5, condition C is met because Balance Date 1 is within 25-35 days of Balance Date 2 or Balance Date 1 equals Balance Date 2. Condition D, 508, is an extra condition to make sure the two months of tradeline data are of the same type and and/or have the same term codes, to avoid mismatching. As shown in FIG. 5, condition D is met and Account Type 1 equals Account Type 2 or Term 1 equals Term 2. Additionally, the tradeline data that is matched may be selected based on a predetermined period of time, for example a period of four months is shown in FIG. 4.

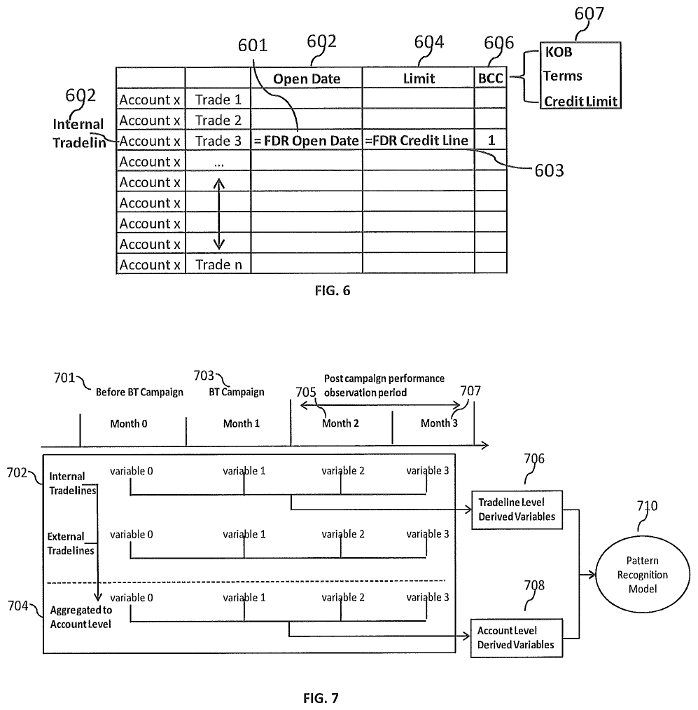

Next, the internal tradeline information in the tradeline data is identified. The internal tradeline information may be isolated from the rest of the tradeline data, including the external tradeline information. FIG. 6 illustrates how internal tradelines are identified. First, the open date 601 and credit line amount 603 of a tradeline are obtained from the internal data of the host financial institution. A tradeline may be identified as an internal trade if the following conditions are satisfied: the tradeline open date 602 equals the internal account open date 601, the tradeline credit limit 604 equals an internal account credit line 603, and the tradeline is a Bankcard Revolving Trade (referred to as “BCC”). A BCC refers to a revolving credit line, without a fixed number of payments, issued for a bankcard as opposed to a non-revolving credit line, which has a fixed number of payments. A BCC 606 may be defined by specific categories of Kind of Business (“KOB”) codes, terms, and credit limit 607. A credit card tradeline is categorized as a BCC.

After the above steps are conducted, internal tradeline data is available, which may consist of months of tradeline data in the neighborhood of a BT campaign month. The tradeline data may be represented in the month before the BT campaign, the month of BT campaign and two months after the BT campaign. This data along with the account actual BT response can be used to develop the Tradeline Level BT Response Model, also called the Tradeline Level Pattern Recognition Model.

The modeling steps to obtain the logistic regression model output as shown include the following:

### 1. Data and Variable Preparation.

For the development and out-of-time validation samples, predictor variables are gathered, including raw variables and derived variables. A development sample is used to develop a model. After a model is developed on the development sample, it is applied to in-time hold out sample and the out-of-time sample (which is sample from different time frame, which may be from a more recent vintage) to check the model's validity.

### 2. Variable Treatments.

The median value is used to replace the missing values of the input variables with missing values. Also variables with extreme values are floored and capped at 0.5% and 99.5% percentiles. Without treating these missing values, the entire observation will not be used in the modeling step even if all other variables do not have missing values. Such a treatment process is called missing imputation step, which helps to use all the non-missing information instead of throw everything away because of missing values. For flooring and capping, i.e. for one variable anything below its 0.5% percentile will be set to its 0.5% percentile; anything above 99.5% percentile will be set to 99.5% percentile. The 0.5% Percentile is the value below which 0.5% of the observations can be found.

### 3. Variable Transformations.

Different transformation techniques can be applied on the input variables to create transformed variables. Here, a Weight of Evidence (“WOE”) transformation is used to obtain the WOE transformed variables. The WOE transformation is done by first binning or discretizing the original predictor variables, for example, 20 equal sized bins may be created initially. Then neighbor bins are collapsed together by comparing the event rates of the two groups. After all the collapsing iterations, final bins are obtained (each bin should be different from the others) and the WOE value is taken as the logarithm of distribution of an event to a non-event. An advantage of WOE transformation is that it allows nonlinearity to be modeled by a linear model.

### 4. Variable Reduction.

Usually the modeling starts with large quantity of candidate input variables (e.g. over 2,000 after transformations) and it is difficult to directly apply variable selection method (e.g. stepwise method). So a variable reduction step may be done first to reduce the candidate variables to a smaller set for a stepwise selection. A commonly used approach is to calculate and rank variables by their correlation with a target variable. A threshold value (e.g., 0.3) may be applied and all variables with a correlation below the threshold value may be dropped. By doing this, the variables can be narrowed down to several hundred, which is more manageable and efficient for the stepwise step.

### 5. Variable Selection Using Stepwise Method

Stepwise method is an algorithm in regression for variable selection. Here a stepwise method was used to select the final model variables for both models. When selecting the variables, signs of their estimate and multicollinearity among variables are also examined to make sure that each variable makes business sense (as illustrated in Table 2) and variables are not severely correlated with each other.

A stepwise method starts by scanning through all variables and adding the most significant variable to the model (a pre-specified significance level is used). Then given the presence of the first variable the stepwise method searches and adds the next significant variable. The significance of the selected variables is checked again and the variables that become in-significant are dropped. The steps are repeated until no more variables can be selected to further improve the model. In addition to the stepwise method, other similar methods, i.e., forward or backward selection methods, can also be used to achieve the same effect. Forward selection adds variables one at a time without removing variables that are already selected. Backward selection uses all available variables first and then drops them one at a time based on a pre-set variable significance level.

### 6. Validate the Model on Development Data and Out-of-Time Data

Once the model is specified it is applied on the in time hold-out and out-of-time samples to check for the validity of the model.

### Tradeline Level Pattern Recognition Model

The account tradelines monthly activity patterns can be summarized and analyzed to learn what kind of patterns the BT responders have versus the BT non-responders with regard to BT response likelihood. This can be done by a rule-based approach, such as manually created rules or Decision Tree. A set of particular rules can be found to identify the patterns. According to a preferred embodiment, a Logistic Regression model is employed to predict the BT response likelihood. A probability of BT response is calculated based on the patterns. Balance and/or utilization changes during the performance period are used to identify account usage patterns of BT responders. The model may be called a pattern recognition model because it uses only the change patterns of the tradeline data as predictors. No behavior and risk attributes are used with the pattern recognition model thereby bias caused by profile differences between internal and external responders is avoided.

FIG. 7 shows how pattern changing variables that can be derived on both tradeline level 702 and the overall customer account level 704. The pattern changing variables are used as predictors to capture both tradeline level activity and the overall customer account level activities. A variety of derived variables may be created to define the patterns. For example, the tradeline balance change between the month after BT campaign 705 and BT campaign month 703, the balance ratios, the balance difference between the second month after BT campaign 707 and BT campaign month 703 are variables that can be used to define a pattern. These derived variables capture what happens at the individual tradeline level. On the other hand, similar variables can be derived at the overall customer account level to aggregate internal and external tradelines and to summarize the overall customer account level behavior.

Examples of derived variables 706 on tradeline level are:

$$tBal\_ 1 = month 1 balance$$

$$tBal\_ 0 = month 0 balance$$

$$tBal\_ 2 = month 2 balance$$

$$tBal\_ 3 = month 3 balance$$

$$tBal\_chg1 = month 1 balance - month 0 balance$$

$$tBal\_chg2 = month 2 balance - month 1 balance$$

$$tBal\_chg3 = month 3 balance - month 2 balance$$

$$tBal\_chg2 \_ 0 = month 2 balance - month 0 balance$$

$$tBal\_chg3 \_ 0 = month 3 balance - month 0 balance$$

$$t\_maxchg = maximum ( tBa1\_chg1 , tBa1\_chg2 , tBa1\_chg3 )$$

$$t\_minchg = maximum ( tBa1\_chg1 , tBa1\_chg2 , tBa1\_chg3 )$$

$$t\_maxchgall = maximum ( tmaxchg , tBa1\_chg2 \_ 0 , tBa1\_chg3 \_ 0 )$$

$$t\_absmaxchg = maximum ( abs ( tBa1\_chg1 ) , abs ( tBa1\_chg2 ) , abs ( tBa1\_chg3 ) )$$

$$t\_balchg = maximum ( tBa1\_ 1 , tBa1\_ 2 , tBa1\_ 3 ) - tBa1\_ 0$$

$$t\_uti1 \_ 1 = Balance at month 1 / Credit Limit$$

$$t\_uti1 \_ 0 = Balance at month 0 / Credit Limit$$

$$t\_uti1 \_ 2 = Balance at month 2 / Credit Limit$$

$$t\_uti1 \_ 3 = Balance at month 3 / Credit Limit$$

$$t\_maxut i1 = maximum ( t\_uti1 \_ 1 , t\_uti1 \_ 0 , t\_uti1 \_ 2 , t\_uti1 \_ 3 )$$

$$t\_avgutil = average ( t\_uti1 \_ 1 , t\_uti1 \_ 0 , t\_uti1 \_ 2 , t\_uti1 \_ 3 )$$

$$tUtili 1 = month 1 utilization - month 0 utilization$$

$$tUtili 2 = month 2 utilization - month 1 utilization$$

$$tUtili 3 = month 3 utilization - month 2 utilization$$

$$t\_Utilmaxchg = maximum ( tUtili 1 , tUtili 2 , tUtili 3 )$$

$$Month on book = Number of months since the tradeline was opened$$

$$t\_Opentobuy \_ 0 = Credit Limit - Balance at month 0$$

$$t\_Opentobuy \_ 1 = Credit Limit - Balance at month 1$$

$$t\_Opentobuy \_ 2 = Credit Limit - Balance at month 2$$

$$t\_Opentobuy \_ 3 = Credit Limit - Balance at month 3$$

Examples of summarized/derived variables 708 on overall customer account level include:

$$Ntrade = total number of tradelines$$

$$a\_mob = average month on book$$

$$a\_limit = average credit limit$$

$$a\_ba10 = sum of all tradeline balances at month 0$$

$$a\_ba11 = sum of all tradeline balances at month 1$$

$$a\_ba12 = sum of all tradeline balances at month 2$$

$$a\_ba13 = sum of all tradeline balances at month 3$$

$$aBal\_chg 1 = month 1 average balance - month 0 average balance$$

$$aBal\_chg 2 = month 2 average balance - month 1 average balance$$

$$aBal\_chg 3 = month 3 average balance - month 2 average balance$$

$$a\_maxchg = maximum ( aBa1\_chg1 , aBa1\_chg2 , aBa1\_chg3 )$$

It should be noted that some variables may be correlated with each other and thus they may not show up in a final model given the other variables that are selected. One of ordinary skill in the art would understand that other variables similar to those listed above, that describe the type of information described herein, may be provided and used within the scope of the present disclosure.

Using the internal tradeline data, the derived variables are used as input to develop the pattern recognition model 710. The internal BT response is used as the binary model target. The input variables with missing values are imputed by substituting the missing values by the variable median values. The imputation step is done to avoid discarding the entire records due to missing in some variables. In addition, to eliminate outliers each input variable is also floored and capped at its 0.5% and 99.5% percentiles respectively, i.e., for each variable any values below its 0.5% percentile are set to its 0.5% percentile while any values above its 99.5% percentile will be set to its 99.5% percentile. The 0.5% percentile is the value below which 0.5% of the observations can be found, the 99.5% percentile is the value above which 99.5% of the observations can be found.

The imputation processed input variables are further transformed using Weight of Evidence (“WOE”) transformation. This WOE transformation is done by first binning or discretizing the original predictor variables. For each variable, 20 equal sized bins are created based on their ranges. Next, the event rates of two neighborhood bins are compared statistically using Chi-square test. Using a cut-off value of 0.1, two bins are combined if they have similar event rates with an insignificant test p-value. This combining process may be repeated iteratively until all remaining bins are statistically different from their neighbor bins. For each bin, the logarithm of distribution of the event to non-event is as calculated as the WOE value. The advantage of using a WOE transformation is that it allows nonlinearity to be modeled by a linear model.

After the missing and outlier treatments, the tradeline level and overall customer account level derived variables and their WOE transformed variables are used as the candidates variables to develop the Tradeline Level Pattern Recognition Model. For model development, a random split of 50% of the accounts from two BT campaigns for predetermined period of time may be used to develop the model and the other 50% is used as for hold-out validation.

A standard stepwise selection method may then be used to select variables for a final iteration of the Tradeline Level Pattern Recognition Model. The stepwise method starts by scanning through all the variables and adding the most significant variable to the model (a pre-specified significance level is used). The stepwise method searches for the final set of variables from a large number of potential explanatory variables. Given the presence of a first variable, it searches and adds the next significant variable. The significance of the selected variables is checked again and the variables that become in-significant are dropped.

Such steps are repeated until no more variables can be selected to improve the model. For the selected final variables, a set of corresponding coefficients are also estimated using Maximum Likelihood Estimation (“MLE”) method to form the final scoring equation. The stepwise procedure and coefficient estimation can be done in a variety of statistics packages and SAS is used in this invention. According to a preferred embodiment, five attributes were selected in the final model including three tradeline level attributes and two overall customer account level attributes.

The final iteration for the Tradeline Level Pattern Recognition Model is as follows:

$$Xbeta 1 = - 3.9 \; 6 + 0.42 * t\_balchg \_ 3 m\_w + 0.54 * t\_maxchg \_w + 0.83 * a\_ntrade \_w + 0.54 * a\_avguti1 \_ 2 \_w + 0.31 * t\_opentobuy \_ 3 \_w$$

$$Score 1 = 1 / ( 1 + exp ( - xbeta 1 ) )$$

The Tradeline Level Pattern Recognition Model is a Logistic Regression model in which the target, a positive BT response, is predicted by pattern change variables, e.g. balance/utilization changes. “Score1” is then the output probability of a positive BT response for each tradeline.

Table 1 gives five final model variables of a preferred embodiment of the pattern recognition model and Table 2 gives explanations of those variables.

TABLE 1

| | Variable | Description |
|---|---|---|
| 1 | t_maxchg_w | Tradeline level: max of month to |
| | | month balance change in 4 months |
| | | around BT campaign month |
| 2 | t_balchg_3m_w | Tradeline level: 3-month balance change |
| 3 | a_avgutil_2_w | Account level: average utilization in the |
| | | month after BT campaign |
| 4 | a_ntrade_w | Account level: total number of bankcard trades |
| 5 | t_opentobuy_3_w | Tradeilne level: open to buy in the |
| | | 2nd month after BT campaign |

TABLE 2
The trade line is more likely to be a BT if

the tradeline has higher month to month incremental balance
during the four months around BT campaign
the tradeline has higher balance change between the month prior
to BT campaign and 2 months after
the tradeline has lower open to buy amount in the month
after BT campaign
the account has higher average bankcard utilization rate in
the month after BT campaign
the account has higher total number of bankcard trades during
the BT campaign month

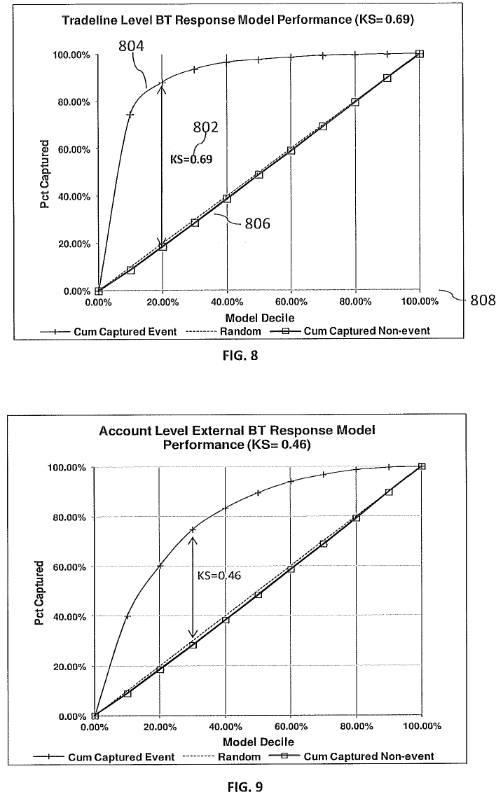

FIG. 8 shows the performance of the pattern recognition model including the three tradeline level attributes and two overall customer account level attributes as discussed above. It has a Kolmogorov-Smirnov statistic (“KS”) 802 of 0.69 on a hold-out sample, which is a sample from the same campaign month that was not used in model development. The KS measures the separation power of a score card by looking at the maximum separation between the cumulative distribution of event 804 and non-event 806, a higher value of KS indicates a model is a better predictor of an actual event. A KS of 0.69 indicates that the model has a strong performance in separating event and non-event, in this case the responders and non-responders to BT offers. As shown in FIG. 8, the top two model deciles, where one decile has 10% of the total sample, capture 88% of the actual BT responders. The model was further validated on accounts from a sample BT campaign as an out-of-time sample, a sample taken from a different campaign month, to check the model's stability and robustness.

An Out of time sample validation is a validation approach in statistical modeling. After a model is developed on a sample from time period A, it is applied on a sample from a different time period B to check the validity of the model on performance (in terms of KS) and stability. The final model discussed above performs well with a KS of 0.75 and 91% of captured BT responders in top two deciles on the out-of-time sample.

Besides the Logistic Regression model, alternative approaches were also explored and compared. A Decision Tree, or rule-based approach, and a Neural Network model were developed and compared with the Logistic Regression model. Table 3 gives the model KS and Gini comparisons. The Gini statistic is similar to KS and also measures the model separation power. As shown in Table 3, the Logistic Regression model and the Neural Network model have similar performance and both models outperform the Decision Tree model. The Logistic Regression model was chosen to minimize complexity of the overall model.

TABLE 3

| Method | KS | Gini |
|---|---|---|
| Logistic Regression | 0.69 | 0.85 |
| Decision Tree | 0.6 | 0.69 |
| Neural Network | 0.7 | 0.86 |

### Overall Customer Account Level BT External Response Model

As previously described, the Tradeline Level Pattern Recognition Model is used to infer the accounts' external BT response likelihood. Table 4 illustrates how overall customer account level probability is obtained from tradeline level probabilities. For an overall customer account A, the tradeline model generates probabilities of BT response Score1_1, Score1_2, . . . , Score1_n for each of the external tradelines 1, 2, . . . , n. The maximum probability Score1_max is used as the overall customer account level external BT probability. By using the maximum of all the probabilities of Account A, the most likely trade that indicates an acceptance of an external BT offer is chosen and the corresponding probability is used as the probability that the customer may have accepted an external BT offer.

TABLE 4

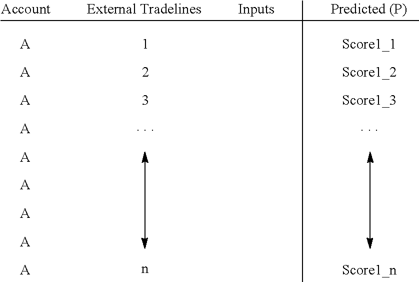

Account Level Probability Score1_max = Max(Score1_1, Score1_2, ... , Score1_n)

To develop the account level model a weighting methodology is used as shown in Table 5. Each record is split in two, as a partially response and a partially non-response. A probability P is assigned to the event and the 1-P is assigned to non-event as a weight. Score1_max obtained in the previous step is used as the probability for each account, therefore Pa is equal to Score1_max for Account A in the example above. Similarly, Pb is equal to Score1_max for a different account, Account B. Note that each account is used twice. The weight is used to reflect the chance of being a responder or non-responder. The response and their associated weights are used as model targets for next stage of model development.

TABLE 5

| Account | Response | Weight |
|---|---|---|
| A | 0 | 1-Pa |
| A | 1 | Pa |
| B | 0 | 1-Pb |
| B | 1 | Pb |

In the second stage modeling, or overall customer account level modeling, historical account behavior information, including internal behavior, credit bureau information, and account relationship variables may be used as model inputs. Other variables may be used at overall customer account level. These variables may be generally summarized as internal data and derived variables that pertain to prior credit card behavior information, such as balance, payment, utilization, etc.; Internal transaction history variables, such as prior BT history, or convenience check history in the previous 24 months; Experian Credit Bureau primary attributes, which includes external financial behavior information, such as a FICO score, external balance/payment, etc., and internal host financial institution data regarding customer/household information (e.g., deposit, investment, loan information of the credit card holder).

Similar to the pattern recognition model discussed above, missing and outlier treatments can be applied on the variables, WOE transformations may be created as candidate input variables and stepwise selection method can be used to select variables. Table 6 provides six variables used in a preferred embodiment of the Overall Customer Account Level Model and Table 7 gives explanations of these variables. It is noted that Lifetime High Balance Amount means the highest balance the account has had during the life of the account. For the selected final variables, the corresponding coefficients are also obtained using Maximum Likelihood Estimation (“MLE”) method to form the final scoring equation.

A final iteration of the Overall Customer Account Level BT External Response Model is as follows:

$$Xbeta 2 = - 2.78 + 0.34 * ALL 3510 \_n \_w + 0.43 * BCA 0300 \_n \_w + 0.66 * REV 7110 \_n \_w + 0.39 * BCC 5320 \_n \_w + 0.26 * HIBALLIF\_w - 0.005 * ALL 8320 \_n$$

$$Score 2 = 1 / ( 1 + exp ( - xbeta 2 ) )$$

The Overall Customer Account Level BT External Response Model is a Logistic Regression model in which the target, a positive BT response, is predicted by the overall customer account level variables. Score2 is the output probability of a customer account responding to BT offer.

TABLE 6

| | Variable | Description |
|---|---|---|
| 1 | REV7110_n_w | Overall balance to credit amount ratio |
| | | on open revolving trades reported |
| | | in the last 6 months |
| 2 | BCA0300_n_w | Total number of bankcard revolving and |
| | | national trades |
| 3 | BCC5320_n_w | Total credit amount on open revolving bankcard |
| | | trades reported in the last 6 months |
| 4 | ALL8320_n | Average number of months since trades were |
| | | opened |
| 5 | ALL3510_n_w | Total number of open and closed trades |
| | | with a balance >$0, excluding derogatory |
| | | trades, reported in the last 6 months |
| 6 | HIBALLIF_w | Lifetime High Balance Amount |

TABLE 7
An account is more likely to respond to external
BT offer if the account has

Higher balance to credit ratio on open revolving trades in last 6 months
Higher total number of bankcard revolving trades
Higher total credit amount on open revolving bankcard trades in last
6 months
Lower average number of months (more recent) since trades were
opened
Higher total number of trades with positive balance in last 6 months
Higher lifetime high balance amount

The words “Higher” and “Lower” used above indicate the relationship between the predictor and target. For example, with all others variables the same, account A with $5,000 life time highest balance is more likely to respond to an external BT offer than account B with $1,000 life time highest balance.

FIG. 9 shows the performance of the preferred embodiment of the account level external BT response model that uses the six variables discussed above. The model performs well and has a KS of 0.46 on hold-out sample. The top two deciles capture 60% of the external BT responders. It also performs well on the out-of-time sample with a KS of 0.45 and 63% of captured external BT responders in top two deciles.

### Final Output

The final output of the present disclosure is the account scores for likelihood of responding to external BT offers. It can be used with an internal BT response model to create new pricing groups to improve a host financial institution's targeting strategy for BT offers. The internal BT response model may be developed based on internal BT campaign data for a host financial institution. The internal BT response model predicts the probability that an account held by the host financial institution will respond to an internal BT offer using an account's historical behavior variables and credit bureau variables.

Table 8 gives an example of a preferred embodiment of segmentation scheme of the present disclosure. As shown in Table 8, an internal BT response decile and an external BT response decile are compared. Eight segments labeled A-H, defining different areas of correspondence are shown. The external BT response decile results from the outcome score of the Overall Customer Account Level Model. The Overall Customer Account Level Model gives a score to each account indicating the probability of account responding to external BT offer. Each of the internal BT response decile and the external BT response decile are created by ranking the accounts by the score from high to low and making ten evenly distributed bins, e.g., decile 1 corresponds to the top 10% of the accounts with highest probabilities that an account will respond to an external BT offer, whereas decile 10 corresponds to the lowest probabilities.

TABLE 8

| Internal | | | | | | | | | | |
|---|---|---|---|---|---|---|---|---|---|---|
| Response | External BT Response Decile | | | | | | | | | |
| Decile | 1 | 2 | 3 | 4 | 5 | 6 | 7 | 8 | 9 | 10 |
| 1 | A | | | | | B | | | | |
| 2 | | | | | | | | | | |
| 3 | C | | D | | | G | | | | |
| 4 | | | | | | | | | | |
| 5 | | | | | | | | | | |
| 6 | E | | F | | | H | | | | |
| 7 | | | | | | | | | | |
| 8 | | | | | | | | | | |
| 9 | | | | | | | | | | |
| 10 | | | | | | | | | | |

Characteristics of the segments and examples of possible actions are listed in Table 9, below. For example, in the preferred embodiment shown, segments C, E, and F consist of accounts with a higher likelihood of responding to external BT offer than to internal BT offer. These segments can be treated with better offers to improve the total response rate.

TABLE 9

| Segment | Likelihood of responding to BT offer | Possible Actions |
|---|---|---|
| A | High internal/High external | Target |
| B | High Internal/Low external | Target |
| C | Medium Internal/High external | Better offer |
| D | Medium internal/Medium external | BAU or better offer |
| E | Low internal/High external | Target/Better offer |
| F | Low internal/Medium external | Selectively target |
| G | Midium internal/Low external | Target |
| H | Low Internal/Low external | Not Target |

### Example Computer System Implementation

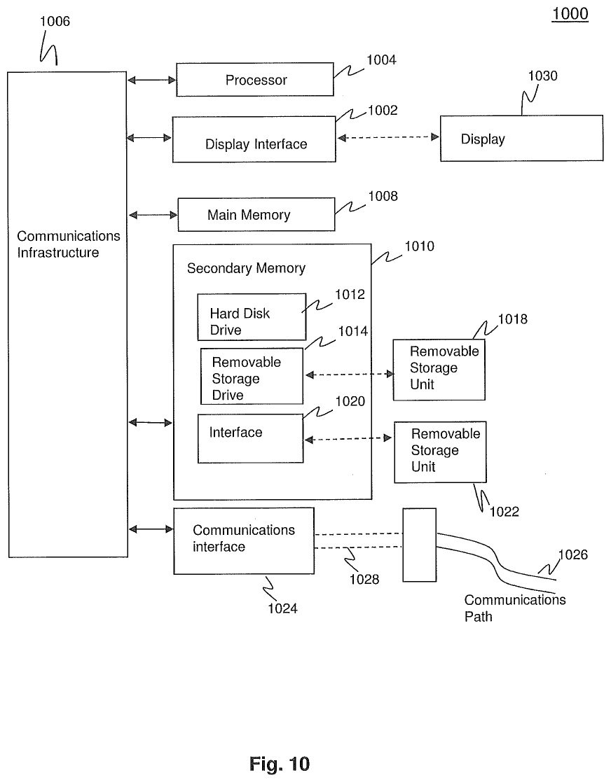

As would be appreciated by someone skilled in the relevant art(s) and described below with reference to FIG. 10, part or all of one or more aspects of the methods and system discussed herein may be distributed as an article of manufacture that itself comprises a computer readable medium having computer readable code means embodied thereon.

The computer readable program code means is operable, in conjunction with a computer system, to carry out all or some of the steps to perform the methods or create the system discussed herein. The computer readable medium may be a recordable medium (e.g., hard drives, compact disks, EEPROMs, or memory cards). Any tangible medium known or developed that can store information suitable for use with a computer system may be used. The computer-readable code means is any mechanism for allowing a computer to read instructions and data, such as magnetic variations on a magnetic media or optical characteristic variations on the surface of a compact disk. The medium can be distributed on multiple physical devices (or . . . over multiple networks). For example, one device could be a physical memory media associated with a terminal and another device could be a physical memory media associated with a processing center.

The computer systems and servers described herein each contain a memory that will configure associated processors to implement the methods, steps, and functions disclosed herein. Such methods, steps, and functions can be carried out, e.g., by processing capability on mobile device, POS terminal, payment processor, acquirer, issuer, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor.

Aspects of the present disclosure shown in FIGS. 2-7, or any part(s) or function(s) thereof, may be implemented using hardware, software modules, firmware, tangible computer readable media having instructions stored thereon, or a combination thereof and may be implemented in one or more computer systems or other processing systems.

FIG. 10 illustrates an example computer system 1000 in which embodiments of the present disclosure, or portions thereof, may be implemented as computer-readable code. For example, the various aspects of the methods described herein can be implemented in computer system 1000 using hardware, software, firmware, non-transitory computer readable media having instructions stored thereon, or a combination thereof and may be implemented in one or more computer systems or other processing systems. Hardware, software, or any combination of such may embody any of the modules and components used to implement the network, systems, methods.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments. A processor device may be a single processor, a plurality of processors, or combinations thereof. Processor devices may have one or more processor “cores.”

Various embodiments of the present disclosure are described in terms of this example computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

The processor device 1004 may be a special purpose or a general purpose processor device. As will be appreciated by persons skilled in the relevant art, processor device 1004 may also be a single processor in a multi-core/multiprocessor system, such system operating alone, or in a cluster of computing devices operating in a cluster or server farm. Processor device 1004 is connected to a communication infrastructure 1006, for example, a bus, message queue, network, or multi-core message-passing scheme.

The computer system 1000 also includes a main memory 1008, for example, random access memory (RAM), and may also include a secondary memory 1010. Secondary memory 1010 may include, for example, a hard disk drive 1012, removable storage drive 1014. Removable storage drive 1014 may comprise a floppy disk drive, a magnetic tape drive, an optical disk drive, a flash memory, or the like.

The removable storage drive 1014 may read from and/or writes to a removable storage unit 1018 in a well-known manner. The removable storage unit 1018 may comprise a floppy disk, magnetic tape, optical disk, Universal Serial Bus (“USB”) drive, flash drive, memory stick, etc. which is read by and written to by removable storage drive 1014. As will be appreciated by persons skilled in the relevant art, the removable storage unit 1018 includes a non-transitory computer usable storage medium having stored therein computer software and/or data.

In alternative implementations, the secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that found in video game devices), a removable memory chip (such as an EPROM, or PROM) and associated socket, and other removable storage units 1022 and interfaces 1020 which allow software and data to be transferred from the removable storage unit 1022 to computer system 1000.

The computer system 1000 may also include a communications interface 1024. The communications interface 1224 allows software and data to be transferred between the computer system 1000 and external devices based on communication networks. The communications interface 1024 may include a modem, a network interface (such as an Ethernet card), a communications port, a PCMCIA slot and card, or the like. Software and data transferred via the communications interface 1024 may be in the form of signals, which may be electronic, electromagnetic, optical, or other signals capable of being received by communications interface 1024. These signals may be provided to the communications interface 1024 via a communications path 1026. The communications path 1026 carries signals and may be implemented using wire or cable, fiber optics, a phone line, a cellular/wireless phone link, an RF link or other communications channels.

In this document, the terms ‘computer readable storage medium,’ ‘computer program medium,’ ‘non-transitory computer readable medium,’ and ‘computer usable medium’ are used to generally refer to tangible and non-transitory media such as removable storage unit 1018, removable storage unit 1022, and a hard disk installed in hard disk drive 1012. Signals carried over the communications path 1026 can also embody the logic described herein. The computer readable storage medium, computer program medium, non-transitory computer readable medium, and computer usable medium can also refer to memories, such as main memory 1008 and secondary memory 1010, which can be memory semiconductors (e.g. DRAMs, etc.). These computer program products are means for providing software to computer system 1000.

Computer programs (also called computer control logic and software) are generally stored in a main memory 1008 and/or secondary memory 1010. The computer programs may: also be received via a communications interface 1024. Such computer programs, when executed, enable computer system 1000 to become a specific purpose computer able to implement the present disclosure as discussed herein. In particular, the computer programs, when executed, enable the processor device 1004 to implement the processes of the present disclosure discussed below. Accordingly, such computer programs represent controllers of the computer system 1000. Where the present disclosure is implemented using software, the software may be stored in a computer program product and loaded into the computer system 1000 using the removable storage drive 1014, interface 1020, and hard disk drive 1012, or communications interface 1024.

### CONCLUSION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue: experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Although the present invention is illustrated and described herein with reference to specific embodiments, the invention is not intended to be limited to the details shown. Rather, various modifications may be made in the details within the scope and range equivalents of the claims and without departing from the present invention.

1. A computer implemented method for generating a Balance Transfer (“BT”) response estimate using a predictive model executed by a processor of a reject inference computer system that has no access to external BT response information, the computer implemented method comprising:
establishing a bank account for a customer, the bank account maintained by one or more computer systems that monitor customer accounts and generate data signals including a balance signal and a payment history signal, wherein the customer is associated with one or more internal and external accounts giving rise to one or more internal tradeline level data signals and one or more external tradeline level data signals;
receiving, by a processor, and storing, in a non-transitory computer readable memory, the one or more internal tradeline level data signals and the one or more external tradeline level data signals;
receiving, by the processor, financial transactions associated with the bank account causing changes in the balance signal and the payment history signal;
executing instructions read from the non-transitory computer readable memory with the processor, the processor being in communication with the one or more computer systems that generate balance and tradeline signals, the instructions causing the processor to generate a data structure by:
deriving predictor variables to determine tradeline activity, the predictor variables being based only on change patterns of the one or more internal tradeline level data signals and/or the one or more external tradeline level data signals, wherein:
Weight of Evidence (“WOE”) transformed variables are generated from the predictor variables by: a) binning the predictor variables; b) statistically comparing event rates of neighboring bins, c) combining neighboring bins having similar event rates until each remaining bin is statistically different from its neighboring bin, d) calculating a WOE value as a logarithm of distribution of an event to a non-event;
an event represents a responder to a BT offer and a non-event represents a non-responder to a BT offer;
the WOE value is used to model nonlinearity by a linear model; and
store the data structure in the non-transitory computer readable memory;
wherein the instructions cause the processor to:
develop a pattern recognition model based at least in part on the WOE transformed variables of the data structure, wherein:
development of the pattern recognition model comprises:
isolating the one or more internal tradeline level data signals from the one or more external tradeline level data signals; and
generating a development data set by merging four months of the one or more internal tradeline level data signals, the development data set being used as a maximum likelihood that a customer would accept the BT offer when the pattern recognition model is applied to the one or more external tradeline level data signals;
apply the pattern recognition model only to the one or more external tradeline level data signals to determine a probability of whether the one or more external tradeline level data signals indicates that an BT offer was accepted by a customer associated with the one or more external tradeline level data signals;
develop an overall customer account level model based on desired historical account behavior;
apply the overall customer account level model to account usage patterns of a plurality of customers to determine, via logistic regression, a likelihood of whether each customer will accept a BT offer from a financial institution other than the host financial institution, the account usage patterns consisting of changes in the balance of an account and the payment history of the account;
rank each customer account based on the determined probability and the likelihood that the customer associated with the account would accept a BT offer from the financial institution;
generate an output including a score value for each customer account based on the ranking; and
identify a customer from the plurality of customers for receiving the BT offer based on the score value and transmitting the BT offer to the identified customer.

2. (canceled)

3. The method of claim 1, further comprising determining an amount for the BT offer based on the score value.

4. The method of claim 1, further comprising determining an interest rate for the BT offer based on the score value.

5. The method of claim 1, wherein the one or more internal tradeline level data signals or the one and/or more external tradeline level data signals comprises monthly data and wherein building the pattern recognition model based on BT response information comprises matching the tradeline level data on monthly basis for a predetermined period.

6. The method of claim 1, wherein the one or more internal tradeline level data signals or the one and/or more external tradeline level data signals further comprises at least one of a date for an opening of each customer account, a credit limit on each customer account, and a type of account for each customer account.

7. The method of claim 6, wherein building the pattern recognition model based on BT response information further comprises at least one of matching an account number in the one or more internal tradeline level data signals and/or the one or more external tradeline level data signals for a first month with an account number in the one or more internal tradeline level data signals and/or the one or more external tradeline level data signals for a second month, matching a date for an opening of an account in the one or more internal tradeline level data signals and/or the one or more external tradeline level data signals for a first month with a date for an opening of an account in the one or more internal tradeline level data signals and/or the one or more external tradeline level data signals for a second month, and matching an account type in the one or more internal tradeline level data signals and/or the one or more external tradeline level data signals for a first month with a date for an account type in the one or more internal tradeline level data signals and/or the one or more external tradeline level data signals for a second month.

8. (canceled)

9. The method of claim 1, further comprising executing a BT offer campaign, wherein the one or more internal tradeline level data signals and/or the one or more external tradeline level data signals comprises information gathered during the BT offer campaign.

10. A computer implemented method for generating a Balance Transfer (“BT”) response estimate using a predictive model executed by a processor of a reject inference computer system that has no access to external BT response information, the computer implemented method comprising:
establishing a bank account for a customer, the bank account maintained by one or more computer systems that monitor customer accounts and generate data signals including a balance signal and a payment history signal, wherein the customer is associated with one or more internal and external accounts giving rise to one or more internal tradeline level data signals and one or more external tradeline level data signals;
receiving, by a processor, and storing, in a non-transitory computer readable memory, the one or more internal tradeline level data signals and the one or more external tradeline level data signals;
receiving, by the processor, financial transactions associated with the bank account causing changes in the balance signal and the payment history signal;
executing instructions read from the non-transitory computer readable memory with the processor, the processor being in communication with the one or more computer systems that generate balance and tradeline signals, the instructions causing the processor to generate a data structure by:
extracting one or more internal tradeline level data signals and overall customer account level attributes according to BT responders and BT non-responders;
deriving predictor variables to determine tradeline activity, the predictor variables being based only on change patterns of the one or more internal tradeline level data signals and/or the one or more external tradeline level data signals, wherein:
Weight of Evidence (“WOE”) transformed variables are generated from the predictor variables by: a) binning the predictor variables; b) statistically comparing event rates of neighboring bins, c) combining neighboring bins having similar event rates until each remaining bin is statistically different from its neighboring bin, d) calculating a WOE value as a logarithm of distribution of an event to a non-event;
an event represents a responder to a BT offer and a non-event represents a non-responder to a BT offer;
the WOE value is used to model nonlinearity by a linear model; and
store the data structure in the non-transitory computer readable memory;
wherein the instructions cause the processor to:
develop a pattern recognition model based on the WOE transformed variables of the data structure, the extracted one or more internal tradeline level data signals, and the account level attributes, wherein development of the pattern recognition model comprises:
isolating the one or more internal tradeline level data signals from the one or more external tradeline level data signals; and
generating a development data set by merging four months of the one or more internal tradeline level data signals, the development data set being used as a maximum likelihood that a customer would accept the BT offer when the pattern recognition model is applied to the external tradeline information;
apply the pattern recognition model only to the one or more external tradeline level data signals to determine a probability of whether the one or more external tradeline level data signals indicates that a BT offer was accepted by a customer associated with the one or more external tradeline data level signals;
develop an overall customer account level model based on desired account level attributes;
apply the overall customer account level model to account usage patterns for the overall customer account level attributes of a plurality of customers to determine, via logistic regression, a likelihood of whether each customer will accept a BT offer from a financial institution other than the host financial institution, the account usage patterns consisting of changes in the balance of an account and the payment history of the account;
rank each customer account based on the determined probability and the likelihood that the customer associated with the account would accept a BT offer from a financial institution other than the host financial institution;
generate an output including a score value for each customer account based on the ranking; and
identify a customer for receiving the BT offer based on the score value and transmitting the BT offer to the identified customer.

11. The method of claim 10, wherein the one or more internal tradeline level data signals or the one and/or more external tradeline level data signals further comprises at least one of a date for an opening of each customer account, a credit limit on each customer account, and a type of account for each customer account.

12. The method of claim 11, wherein building the pattern recognition model based on the one or more extracted internal tradeline level data signals and overall customer account level attributes comprises at least one of matching an account number in the one or more internal tradeline level data signals and/or the one or more external tradeline level data signals for a first month with an account number in the one or more internal tradeline level data signals and/or the one or more external tradeline level data signals for a second month, matching a date for an opening of an account in the one or more internal tradeline level data signals and/or the one or more external tradeline level data signals for a first month with a date for an opening of an account in the one or more internal tradeline level data signals and/or the one or more external tradeline level data signals for a second month, and matching an account type in the one or more internal tradeline level data signals and/or the one or more external tradeline level data signals for a first month with a date for an account type in the one or more internal tradeline level data signals and/or the one or more external tradeline level data signals for a second month.

13. The method of claim 10, further comprising deriving, a derived variable to determine tradeline activity, wherein the derived variable comprises at least one of a tradeline balance change between a first month and a second month, a maximum of a tradeline balance change between monthly periods over a predetermined number of months, a tradeline utilization between a first month and a second month, a maximum of a tradeline utilization between monthly periods over a predetermined number of months, and a number of months since a tradeline was opened.

14. The method of claim 10, further comprising deriving a derived variable to determine overall customer account level activity, wherein the derived variable comprises at least one of a total number of tradelines associated with a customer, an average credit limit for a total number of tradelines associated with a customer, a sum of balances of all tradelines associated with a customer at a first month, a sum of balances of all tradelines associated with a customer at a second month, an average balance of all tradelines associated with a customer between monthly periods over a predetermined number of months, and a maximum of an average balance of all tradelines associated with a customer between monthly periods over a predetermined number of months.

15. The method of claim 10, further comprising determining an amount for the BT offer based on the score value.

16. (canceled)

17. The method of claim 10, wherein the one or more internal tradeline level data signals and/or the one or more external tradeline level data signals comprises monthly data and wherein building the pattern recognition model based on the one or more extracted internal tradeline level data signals and overall customer account level attributes comprises matching the one or more internal tradeline level data signals on a monthly basis for a predetermined period.

18. (canceled)

19. The method of claim 10, further comprising executing a BT offer campaign to the customers of the financial institution, wherein the one or more tradeline level data signals and/or the one or more external tradeline level data signals comprises information gathered during the BT offer campaign.

20. The method of claim 10, wherein the account level attributes comprise at least one of an overall balance to credit amount ratio on open revolving trades in a predetermined period, total number of bankcard revolving and national trades, total credit amount on open revolving bankcard trades in a predetermined period, average period of time since trades were opened, total number of opened and closed trades with positive balance in a predetermined period, or lifetime high balance amount.
